(19) United States
(12) Patent Application Publication
(10) Pub. No.: US 2026/0105254 A1
(43) Pub. Date: Apr. 16, 2026

(54) PREDICTING INTENT USING CONTEXT-AWARE NATURAL LANGUAGE UNDERSTANDING MODEL

(71) Applicant: Walmart Apollo, LLC, Bentonville, AR (US)

(72) Inventors: Subhadip Nandi, Hooghly (IN); Neeraj Agrawal, Agra (IN); Priyanka Bhatt, Faridabad (IN); Anshika Singh, Ghaziabad (IN); Sudipta Modak, Bengaluru (IN); Anirudh Sharma, Bengaluru (IN)

(73) Assignee: Walmart Apollo, LLC, Bentonville, AR (US)

(21) Appl. No.: 18/915,110

(22) Filed: Oct. 14, 2024

(51) Int. Cl. G06F 40/30; G06N 20/00

(52) U.S. Cl. CPC G06F 40/30; G06N 20/00

(57) ABSTRACT

A system is provided including a processor and a non-transitory computer-readable medium storing computing instructions that cause the processor to perform: generating, by a pretrained bidirectional encoder representations from transformers (BERT) model, a query embedding vector; generating, by a preprocessor, a context vector; receiving, by an attention component, the query embedding and the context vectors; generating, by an attention component, an attention vector based on the query embedding and the context vectors; generating an attention-weighted context vector by multiplying the attention and context vectors; generating a combined embedding by concatenating the attention-weighted context and query embedding vectors; receiving, by a multi-layer perceptron (MLP) of a context-aware natural language understanding (NLU) model, at least one of the combined embedding or the attention-weighted context vector; and generating, by the MLP, at least one predicted intent of the user based on at least one of the combined embedding or the attention-weighted context vector.

### TECHNICAL FIELD

This disclosure relates generally to predicting intent with a Natural Language Understanding (NLU) model, and more particularly, to predicting intent using a context-aware NLU model.

### BACKGROUND

A chat model (e.g., a chatbot) is a conversational system that leverages Natural Language Understanding (NLU) to classify a semantic meaning (e.g., an intent) of at least one utterance (e.g., a query, a response, an explanation, and/or a clarification, etc.) input to the chat model by a user. In most cases, the chat model classifies the intent of the user based solely on an initial query input by the user and then directs the user to an automated workflow of chat model dialogue (e.g., a set of predetermined dialogue prompts/steps related to the initial query and/or aimed at resolving an issue identified in the initial query of the user). However, chat models that primarily or exclusively rely on the initial query of the user and/or rely on piecemeal and often imperfect subsequent utterances of the user (e.g., utterances that are vague, include typos, and/or include tangential/confounding/non-relevant information, etc.) often encounter difficulties in accurately classifying the intent of the user on a consistent basis, efficiently resolving user issues, avoiding escalation to a human representative (e.g., a customer care agent), and/or accurately directing users to an appropriate corresponding automated workflow.

### BRIEF DESCRIPTION OF THE DRAWINGS

To facilitate further description of the embodiments, the following drawings are provided in which:

FIG. 1 illustrates a front elevational view of a computer system that is suitable for implementing aspects disclosed herein, according to an example embodiment;

FIG. 2 illustrates a representative block diagram of elements included in the circuit boards inside a chassis of the computer system of FIG. 1, according to an example embodiment;

FIG. 3 illustrates a block diagram of a baseline model architecture, which can be used independently, or included in a context-aware NLU model and/or an architecture thereof used to predict intent, according to an example embodiment.

FIG. 4 illustrates a block diagram of a context-aware NLU model that includes a Concat with Attention Weighted Context (CAWC) architecture used to predict intent, according to an example embodiment;

FIG. 5 illustrates a block diagram of a context-aware NLU model that includes a Multi-Task Learning (MTL) paradigm for Contextual NLU model (MTL-CNLU) architecture used to predict intent, according to an example embodiment;

FIG. 6 illustrates a block diagram of a context-aware NLU model that includes an MTL-CNLU with Attention Weighted Context (MTL-CNLU-AWC) architecture used to predict intent, according to an example embodiment;

FIG. 7 illustrates a block diagram of a context-aware NLU model that includes an MTL-CNLU with Selective Attention Weighted Context (MTL-CNLU-SAWC) architecture used to predict intent, according to an example embodiment;

FIG. 8 illustrates a block diagram of a system that can include a context-aware NLU model that can include one of the architectures used to predict intent illustrated in the example embodiments of FIG. 5, 6, or 7, according to an example embodiment; and

FIG. 9 illustrates a flowchart for a method of predicting user intent using a context-aware NLU model, according to an example embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for various lengths of time, e.g., permanent, or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DETAILED DESCRIPTION

As aforementioned, a chat model serves as a conversational system aimed at classifying a semantic meaning (e.g., an intent) of a user query input, such as to identify and promptly address an issue of the user. By directing users to automated workflows based on the classified semantic meaning of the query, chat models can theoretically enable faster resolution of user issues and avoid escalations to a human representative. An aspect of practical use and efficacy of chat models is thus accurately classifying the intent of the user query. However, most chat models, such as in the customer care domain, rely solely on an initial user query and/or subsequent utterances for classifying an intent of the user. As is also the case with utterances of a user more generally, an input initial query of the user can be inadvertently confounding to the chat model and result in reduced chat model classification accuracy and timely issue resolution without escalation. For example, a query of a user such as “I did not receive my package” can indicate either a delayed order or a delivered order that the user failed to receive, each potential query intent is associated with a different intent classification, issue to be identified, concomitant issue resolution, and/or corresponding automated workflow.

Example embodiments of the disclosure described herein are directed to context-aware NLU models and/or architectures thereof that effectively leverage contextual information associated with the user in addition to an initial query and/or subsequent utterances of the user, such as a transaction history of the user (e.g., order history of the user, items ordered by the user, and/or an order delivery status related to order(s) of the user, etc.), related prior/dynamic conversations of the user, etc., to provide accurate prediction of intent for the user and/or quickly resolve a misclassification without escalation to a human representative. Many example embodiments disclosed herein can include a novel selective attention component (also referred to herein as an attention module (AM)). The attention component can, for example, identify the most relevant context features of a plurality of context features associated a query of the user before subsequent utilization of the identified most relevant context features in various other steps involved in predicting intent of the user.

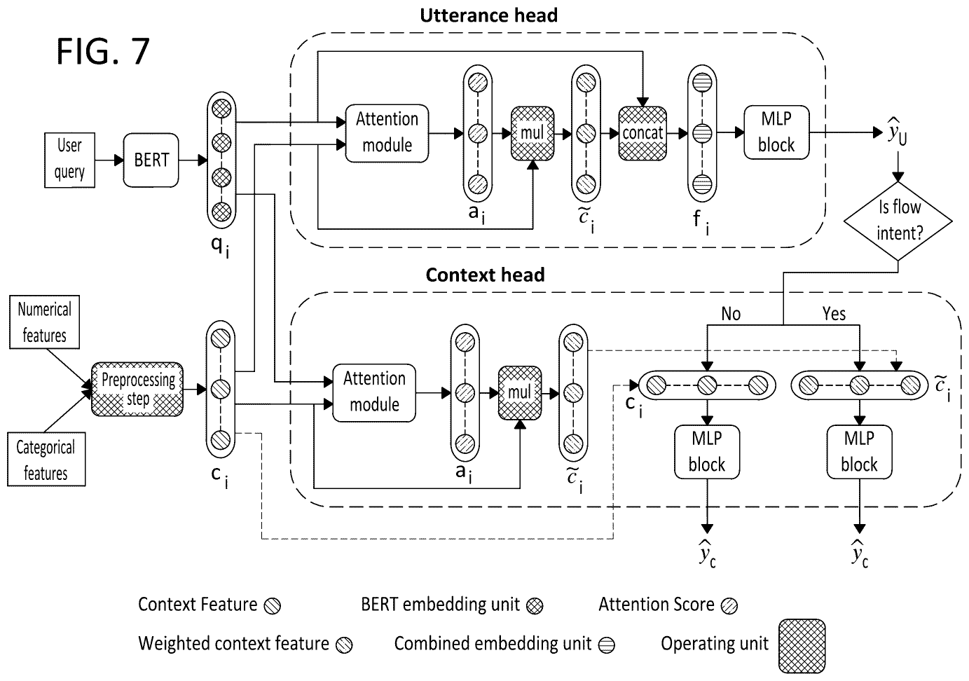

Example embodiments can include a multi-task learning (MTL) paradigm that can effectively utilize different types of labels associated with a user (e.g., utterance labels, context labels (e.g., transaction history labels and/or conversation labels), such as for training, predicting, and/or dynamically updating a context-aware NLU chat model for predicting intent of the user. In some example embodiments, the conversation labels can include uniquely generated conversation labels that can reflect derived inferences to facilitate greater accuracy in predicting an intent of a user. Example embodiments, such as the context-aware NLU model that include a Multi-Task Learning-Contextual NLU with Selective Attention Weighted Context (MTL-CNLU-SAWC), as described and illustrated with reference to FIG. 7, experimentally demonstrate a 4.8% increase in top 2 intent accuracy scores compared to the baseline model that only uses user queries, and a 3.5% improvement in top 2 intent accuracy scores over existing state-of-the-art models that combine query and context in a different manner.

Furthermore, many example embodiments that include the context-aware NLU model and/or architectures thereof can become progressively even more successful at predicting intent as the context-aware NLU model learns from complex, nuanced, and varied contextual scenarios and utterances. The cumulative benefits, such as for an ecommerce marketplace, can include substantial cost savings and revenue improvements to the ecommerce marketplace, greater customer retention for the ecommerce marketplace, greater general customer satisfaction with the ecommerce marketplace, mitigation of avoidable order cancellations by customers of the ecommerce marketplace, and/or reduced escalations to customer care representatives of the ecommerce marketplace.

According to an example embodiment, a system is provided. The system includes a processor and a non-transitory computer-readable medium storing computing instructions that, when executed on the processor, cause the processor to perform operations including: generating, by a pretrained bidirectional encoder representations from transformers (BERT) model, a query embedding vector based on a query of a user; generating, by a preprocessor, a context vector based on context features associated with the user; receiving, by at least one attention component, the query embedding vector and the context vector; generating, by the at least one attention component, an attention vector based on the query embedding vector and the context vector; generating an attention-weighted context vector by multiplying the attention vector with the context vector; generating at least one combined embedding by concatenating the attention-weighted context vector with the query embedding vector; receiving, by at least one multi-layer perceptron (MLP) of a context-aware natural language understanding (NLU) model, at least one of the at least one combined embedding or the attention-weighted context vector; and generating, by the at least one MLP, at least one predicted intent of the user based on at least one of the at least one combined embedding or the attention-weighted context vector.

According to an example embodiment, a computer-implemented method of predicting intent with a context-aware natural language understanding (NLU) model is provided. The computer-implemented method including: generating a query embedding vector based on a query of a user; generating a context vector based on context features associated with the user; generating an attention vector based on the query embedding vector and the context vector; generating an attention-weighted context vector by multiplying the attention vector with the context vector; generating at least one combined embedding by concatenating the attention-weighted context vector with the query embedding vector; receiving, by at least one multi-layer perceptron (MLP), at least one of the at least one combined embedding or the attention-weighted context vector; and generating, by the at least one MLP, at least one predicted intent of the user based on at least one of the at least one combined embedding or the attention-weighted context vector.

According to an example embodiment, a non-transitory computer-readable medium storing instructions is provided. The instructions, upon execution by a processor, cause the processor to perform operations including: receiving, by a pretrained bidirectional encoder representations from transformers (BERT) model, a query of a user; receiving, by a preprocessor, context features associated with context data of the user; generating, by the pretrained BERT model, a query embedding vector based on the query of the user; generating, by the preprocessor, a context vector based on the context features associated with context data of the user; receiving, by at least one attention component, the query embedding vector and the context vector; generating, by the at least one attention component, an attention vector based on the query embedding vector and the context vector; generating an attention-weighted context vector by multiplying the attention vector with the context vector; generating at least one combined embedding by concatenating the attention-weighted context vector with the query embedding vector; receiving, by at least one multi-layer perceptron (MLP) of a context-aware natural language understanding (NLU) model, at least one of the at least one combined embedding or the attention-weighted context vector; and generating, by the at least one MLP, at least one predicted intent of the user based on at least one of the at least one combined embedding or the attention-weighted context vector.

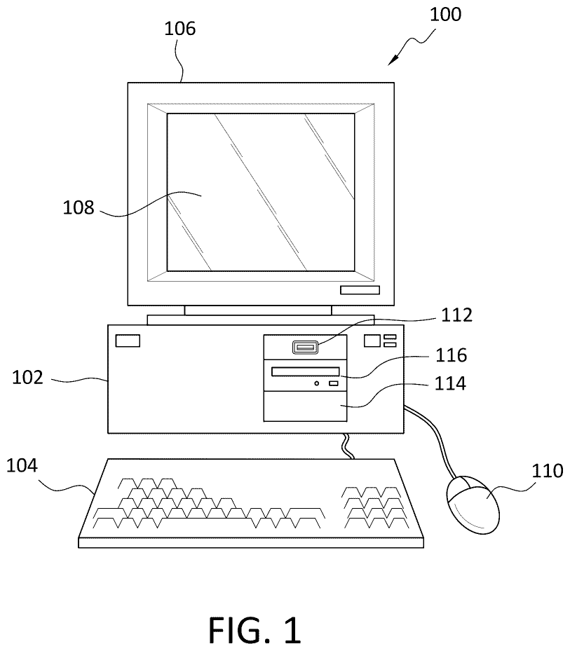

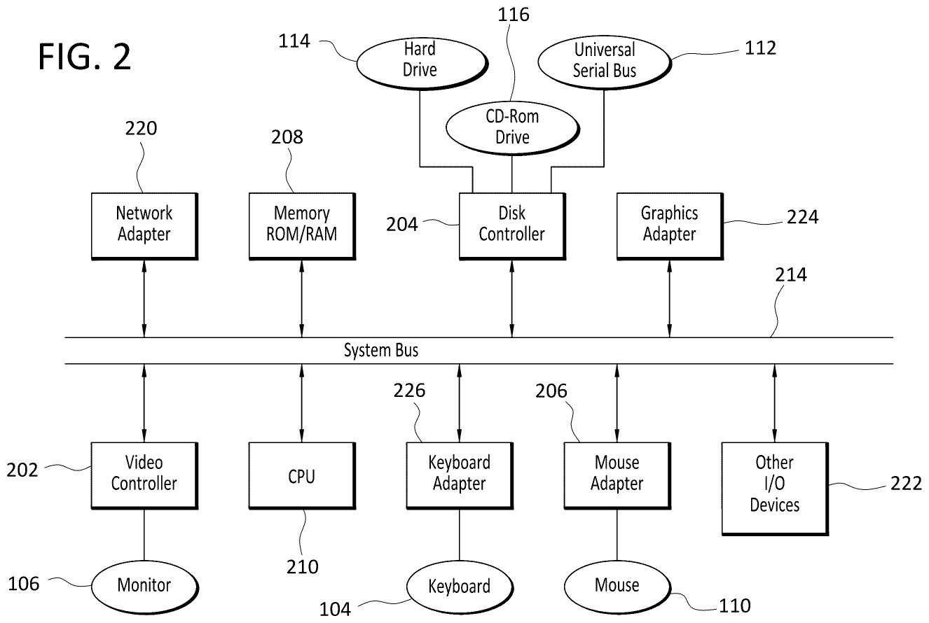

Turning to the drawings, FIG. 1 illustrates an example embodiment of a computer system 100, all of which or a portion of which can be suitable for (i) implementing at least partial or all example embodiments of the techniques, methods, and systems and/or (ii) implementing and/or operating part or all example embodiments of the non-transitory computer readable media described herein. As an example, a different or separate one of the computer system 100 (and its internal components, or at least one element of the computer system 100) can be suitable for implementing partial or all the techniques described herein. The computer system 100 can comprise a chassis 102 which can contain at least one circuit boards (not shown), a Universal Serial Bus (USB) port 112, a Compact Disc Read-Only Memory (CD-ROM), a Digital Video Disc (DVD) drive 116, and/or a hard drive 114. A representative block diagram of the elements included on the circuit boards inside the chassis 102 is shown in FIG. 2, according to an example embodiment. A central processing unit (CPU) 210 illustrated in FIG. 2 can be coupled to a system bus 214 in FIG. 2. In various example embodiments, an architecture of the CPU 210 can be compliant with a variety of commercially distributed architecture families.

Continuing with FIG. 2, a system bus 214 can be coupled to at least one memory storage unit 208 that can include both read only memory (ROM) and random access memory (RAM). Non-volatile portions of the memory storage unit 208 and/or the the ROM can be encoded with a boot code sequence suitable for restoring the computer system 100 (FIG. 1) to a functional state, such as after a system reset. In addition, the memory storage unit 208 can include microcode, such as a Basic Input-Output System (BIOS). In some example embodiments, the at least one memory storage units of the various embodiments disclosed herein can include the memory storage unit 208, a USB-equipped electronic device (e.g., an external memory storage unit (not shown) coupled to the USB port 112 (FIGS. 1-2), the hard drive 114 (FIGS. 1-2), the CD-ROM, the DVD, the Blu-Ray, and/or other suitable media, such as media configured to be used for the CD-ROM and/or the DVD drive 116 (FIGS. 1-2). Non-volatile and/or non-transitory memory storage unit(s) can refer to the portions of the memory storage units(s) that are non-volatile memory and are not transitory signals. In the same or different example embodiments, the at least one memory storage units of the various embodiments disclosed herein can include an operating system, which can be a software program that manages the hardware and software resources of a computer and/or a computer network. The operating system can perform tasks such as, for example, at least one of controlling and/or allocating memory, prioritizing the processing of instructions, controlling input and/or output devices, facilitating networking, and/or managing files. Example operating systems can include at least one of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further example operating systems can comprise one of the following: (i) the iOS® operating system by Apple Inc. of Cupertino, California, United States of America, (ii) the WebOS operating system by LG Electronics of Seoul, South Korea, (iii) the Android™ operating system developed by Google, of Mountain View, California, United States of America, or (iv) the Windows Mobile™ operating system by Microsoft Corp. of Redmond, Washington, United States of America.

As used herein, “processor” and/or “processing module” can mean various types of computational circuits, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, and/or various other types of processors and/or processing circuits capable of performing the desired functions. In some example embodiments, the at least one processors of the various embodiments disclosed herein can comprise the CPU 210.

In the example embodiment illustrated in FIG. 2, various I/O devices such as a disk controller 204, a graphics adapter 224, a video controller 202, a keyboard adapter 226, a mouse adapter 206, a network adapter 220, and/or other I/O devices 222 can be coupled to the system bus 214. The keyboard adapter 226 and/or the mouse adapter 206 can be coupled to a keyboard 104 (FIGS. 1-2) and/or a mouse 110 (FIGS. 1-2), respectively, of the computer system 100 (FIG. 1). The graphics adapter 224 and/or the video controller 202 can be indicated as distinct units in FIG. 2, the video controller 202 can be integrated into the graphics adapter 224, or vice versa in other example embodiments. The video controller 202 can be suitable for refreshing a monitor 106 (FIGS. 1-2) to display images on the screen 108 (FIG. 1) of the computer system 100 (FIG. 1). The disk controller 204 can control the hard drive 114 (FIGS. 1-2), the USB port 112 (FIGS. 1-2), the CD-ROM, and/or the DVD drive 116 (FIGS. 1-2). In other example embodiments, distinct units can be used to control each of these devices separately.

In some example embodiments, the network adapter 220 can comprise and/or be implemented as a WNIC (wireless network interface controller) card (not shown) plugged and/or coupled to an expansion port (not shown) in the computer system 100 (FIG. 1). In other example embodiments, the WNIC card can be a wireless network card built into computer system 100 (FIG. 1). A wireless network adapter can be built into the computer system 100 (FIG. 1), such as by having wireless communication capabilities integrated into the motherboard chipset (not shown) or implemented via at least one dedicated wireless communication chips (not shown), connected through a PCI (peripheral component interconnector), a PCI express bus of the computer system 100 (FIG. 1), and/or the USB port 112 (FIG. 1). In other example embodiments, the network adapter 220 can comprise and/or be implemented as a wired network interface controller card (not shown).

Although some components of the computer system 100 (FIG. 1) might not be shown in the FIGS., such components and their interconnection may be appreciated by those of ordinary skill in the art. Accordingly, further details concerning the construction and/or composition of the computer system 100 (FIG. 1) and/or the circuit boards inside the chassis 102 (FIG. 1) might be omitted herein.

When the computer system 100 in FIG. 1 is running, program instructions stored on a USB drive in the USB port 112, on the CD-ROM, the DVD in the CD-ROM, and/or the DVD drive 116, on the hard drive 114, and/or in the memory storage unit 208 (FIG. 2) can be executed by the CPU 210 (FIG. 2). At least a portion of the program instructions, such as stored on at least one of these devices, can be suitable for carrying out all or at least a part of the techniques described herein. In various example embodiments, the computer system 100 can be reprogrammed with at least one of at least one module, system, application, and/or database, such as those described herein, to convert a general purpose computer to a special purpose computer. For purposes of illustration, programs and other executable program components are shown herein as discrete systems, although it is understood that such programs and components may reside, at various times, in different storage components of computer system 100, and can be executed by the CPU 210. Additionally, or alternatively, the systems and/or procedures described herein can be implemented in hardware, and/or a combination of hardware, software, and/or firmware. For example, at least one application specific integrated circuit (ASIC) can be programmed to carry out at least one of the systems and procedures described herein. For example, at least one of the programs and/or executable program components described herein can be implemented in at least one ASIC.

Although the computer system 100 is illustrated as a desktop computer with reference to FIG. 1, it is not limited thereto. The computer system 100 can take a different form factor and can still having functional elements like those described with respect to the computer system 100. In some example embodiments, the computer system 100 can comprise at least one of at least one single computer, a single server, a cluster/collection of computers/servers, and/or a cloud of computers/servers. Typically, a cluster or collection of servers can be used when the demand on computer system 100 exceeds the reasonable capability of a single server and/or computer. In some example embodiments, the computer system 100 can comprise a portable computer, such as a laptop computer. In some example embodiments, the computer system 100 can comprise a mobile device, such as a smartphone. In some example embodiments, the computer system 100 can comprise an embedded system.

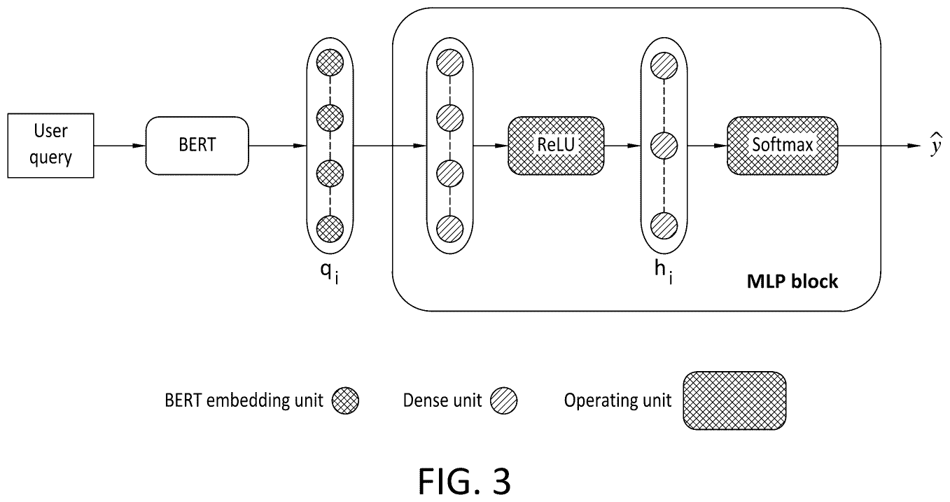

FIG. 3 illustrates a block diagram of a baseline model architecture, which can be used independently, or included in a context-aware NLU model (e.g., a context-aware NLU chat model) and/or an architecture thereof used to predict intent, according to an example embodiment. With respect to the baseline model, at least one utterance (e.g., a query, a response, an explanation, and/or a clarification, etc.) of at least one user (e.g., an ecommerce marketplace customer) can be input into a pretrained Bidirectional Encoder Representations from Transformers (BERT) model. The BERT model can output an embedding vector qᵢ (e.g., a query embedding vector of the query of the user). The embedding vector qᵢ can be a predetermined length. The embedding vector qᵢ can include one or more BERT embedding units. The resultant embedding vector qᵢ can be passed through a Multi-Layer Perceptron (MLP) (also referred to herein an MLP block). The MLP can include one or more of a first layer and a second layer (e.g., a first hidden layer and/or a second hidden layer), at least one of which can be a linear layer. An output of the first layer (e.g., a first linear layer) can include one or more dense units. A collective length of the one or more dense units can correspond to a collective length of the one or more BERT embedding units. The one or more dense units can be input into a Rectified Linear Unit (ReLU) activation function layer included in the MLP. An output of a second layer hᵢ (e.g., a second linear layer) can be input into a Softmax layer included in the MLP. The Softmax layer can output at least one probability for at least one intent of a user. The at least one intent (e.g., a most probable intent) can correspond to a predicted intent of the user y\hat{ } in relation to the query.

Given dataset D=(xᵢ, yᵢ), that can include N different classes and M examples, the BERT model can be fine-tuned and/or the MLP can be trained. The at least one probability output from the baseline model can be represented as follows:

$$p ( y \vert {h}_{i} ) = softmax ( {h}_{i} ) ∈ {R}^{N} \qquad ( 1 )$$

Where hᵢ∈R^{N} can represent the output from a last layer (e.g., the second linear layer) of the two layers that can be included in the MLP, such as before the input into the Softmax layer, for the i-th example xᵢ. Model parameters θ can be trained on D, such as with cross-entropy loss.

$${θ}^{*} = {argmin}_{θ} {ℒ}_{ce} ( D ; θ ) \qquad ( 2 )$$

Cross-entropy loss can be defined as:

$${ℒ}_{ce} = - {\sum }_{i = 1}^{M} {\sum }_{c = 1}^{N} {y}_{i , c} log ( {p}_{i , c} ) \qquad ( 3 )$$

Where p_{i,c} can represent a predicted probability of the i-th example belonging to a class c, and y_{i,c}∈{1, 0} depending on whether c is a true class for the i-th example or not. ŷ can denote an intent class with a maximum probability.

### Example Architecture to Combine User Utterance and Context

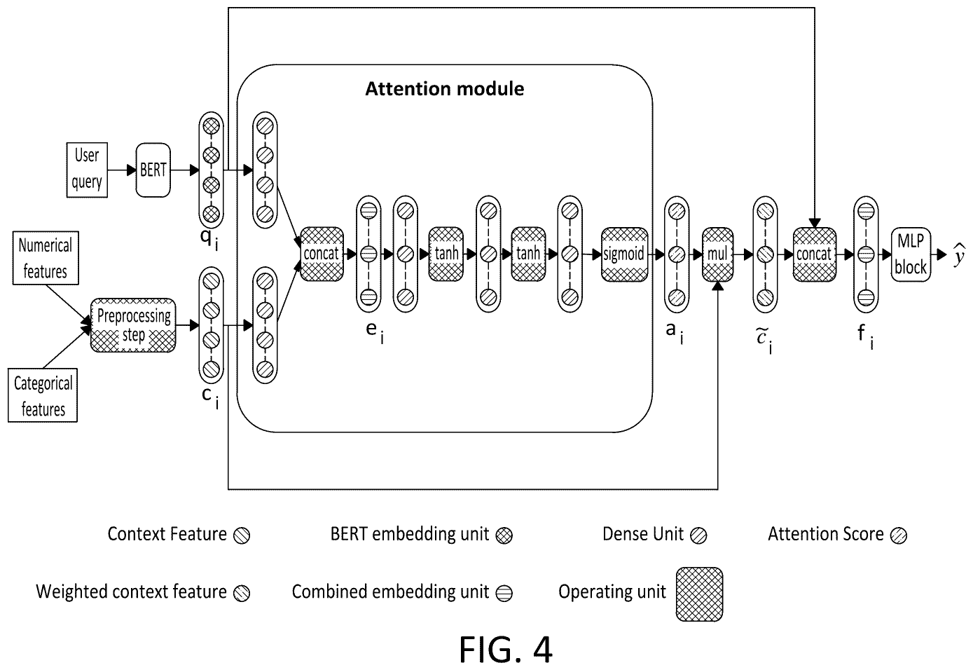

FIG. 4 illustrates a block diagram of a context-aware NLU model (e.g., a context-aware NLU chat model) that includes a Concat with Attention Weighted Context (CAWC) architecture used to predict intent, according to an example embodiment.

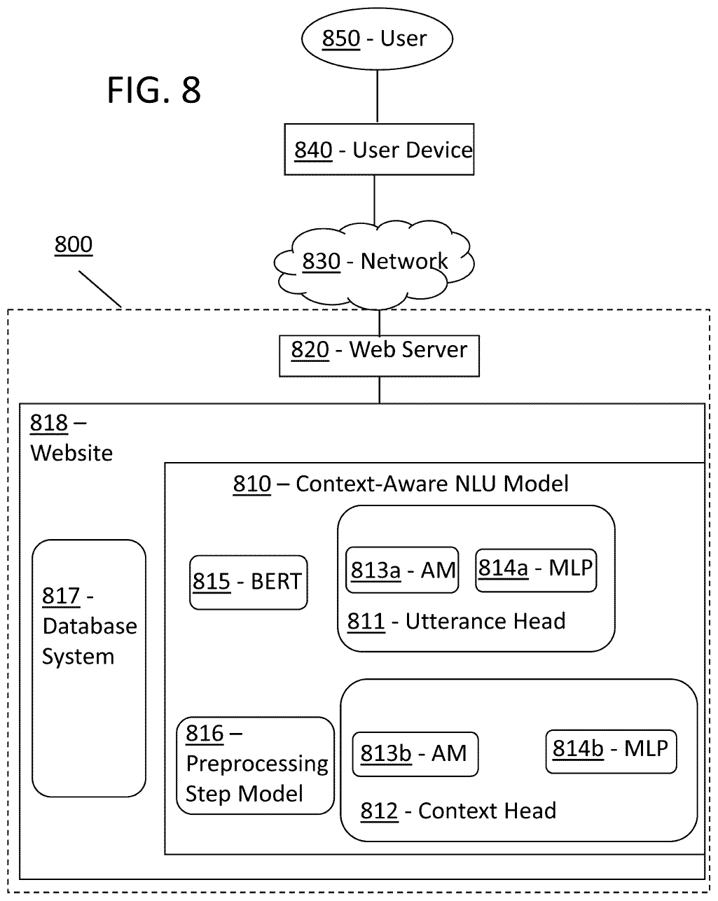

One or more context features used in conjunction with example embodiments of the context-aware NLU model and/or architectures thereof, such as the example embodiments illustrated and described with respect to FIGS. 4-8, can initially be generated/obtained/labeled from prior and/or dynamic context data (e.g., the user's past transaction history data (e.g., order history, items included in one or more orders, delivery statuses, etc.) and/or available conversation data (e.g., prior communication history with the context-aware NLU model, another chat model, and/or a customer care representative)). The user's context data can be obtained via one or more connected relevant repositories/databases (e.g., a database system 817 illustrated and described with reference to FIG. 8), such as upon a triggering condition (e.g., an identified query input and/or an identified user (e.g., based on a present login session, legal name, user credentials, IP address, and/or recognized devices, etc.). The obtained past transaction data of the user can include one or more pre-extracted context features (e.g., features populated in an associated table), and/or one or more preformatted/preprocessed context features. Additionally, or alternatively, the user's past transaction history data can be analyzed using a relevant machine learning process (e.g., an NLP model, such as a same or different NLP model as the NLP model included in the context-aware NLU model and/or the architecture thereof).

Types of the one or more context features can include one or more numerical context features and/or one or more categorical context features. The one or more context features can be obtained from a repository/database that comprises the context data, such as the transaction history of the user (e.g., the order history of the user) and/or conversation history of the user (e.g., prior/dynamic conversations with at least one customer care agent and/or at least one chat model, such as a chat model included in the context-aware NLU model). As aforementioned, the one or more context features can be obtained in a preprocessed form, pre-labelled, and/or pre-extracted using a relevant machine learning model. The one or more context features can include at least one order-level context feature associated with one or more orders, such as one or more of one or more order placement times for the one or more orders; one or more item counts for the one or more orders; one or more store/vendor numbers/identities/types/brands associated with one or more items in the one or more orders; and/or one or more delivery fulfillment types for the one or more items and/or the one or more orders, etc.

The context data pre-obtainment and/or as obtained can be filtered by one or more predetermined criteria (e.g., date/time range, based on predetermined orders of the one or more orders, based on predetermined items of the one or more orders, based on predetermined item types of one or more items includes in the one or more orders, etc.), one or more inputs by the user, and/or by default predetermined filters (e.g., one or more items and/or one or more orders within the last day, week, month, year, etc.). Additionally, the one or more context features can comprise one or more of one or more item-level context features, such as one or more delivery statuses for one or more items (e.g., each item or one or more items identified from the in association with the query of the user) in the one or more orders, one or more item cancellations, one or more item refunds, and/or one or more refund requests for the one or more items included in the one or more orders, etc.

Example embodiments can involve combining the one or more item-level context features corresponding to the one or more order-level context feature to generate one or more unique context features (also referred to herein as one or more handcrafted context features or one or more custom context features), such as one or more of “a number of items delivered”; “a time difference between the last delivered item and a current/past user chat”; and/or “a time difference between the last shipped item and a current/past user chat,” etc. These custom context features can further be utilized to generate at least one additional custom context feature, such as “are any items left to be delivered”, “are any items left to be shipped,” etc. For instance, an additional custom context feature “are any items left to be delivered” can be generated by identifying if the number of items ordered by the user is equal to s number of items delivered to the user. The context features, custom context features, and/or additional custom context features can be based on expert labelling during training training/updating and/or autonomously by machine learning processes. The at least one custom context feature can facilitate the context-aware NLU model's learning of complex feature interactions and has demonstrated enhanced performance, as evidenced in Table 1:

TABLE 1

| Model trained on | top 1 accuracy (%) |
|---|---|
| text only (baseline) | 78.65 |
| text + order level features | 79.34 |
| text + item level features | 78.91 |
| text + order level + item level features | 79.42 |
| text + order level + item level features + | 81.04 |
| handcrafted features | |

In an example embodiment, the one or more custom context features can include one or more custom context features included in Table 2:

TABLE 2

| Feature | Feature type |
|---|---|
| time difference between last delivered item | numerical |
| and user chat | |
| time difference between last shipped item and | numerical |
| user chat | |
| time difference between last cancelled item | numerical |
| and user chat | |
| are any items left to be delivered | categorical |
| are all items left to be delivered | categorical |
| are any items left to be shipped | categorical |
| are any items past expected delivery time | categorical |
| are all items past expected delivery time | categorical |
| were any items cancelled by store | categorical |
| were any items cancelled by customer | categorical |

The example embodiments of FIGS. 4-8 can include the baseline model (e.g., as described with respect to FIG. 3) and/or the BERT model (e.g., pretrained) thereof to obtain embeddings from textual media included in utterance data of the user (e.g., the query of the user), conversation data of the user (e.g., when used as a proxy for transaction history data), and/or the context data of the user.

The one or more context features (e.g., the original one or more context features, the one or more custom context features, and/or the one or more additional context features, etc.) can undergo a preprocessing step. The preprocessing step can include a min-max normalization and/or an imputation of any missing values. As with the baseline model, a query of the user can be input into the BERT model. The at least one embedding of the BERT model can be combined with the at least one context feature, as preprocessed, and the resultant combined embedding can be input into the MLP. Among the numerous techniques for combining query and context, the most straightforward approach may be to concatenate at least one query embedding and at least one context embedding. However, it is challenging for MLP layers to attend to relevant information in the context vector for a given query embedding. Performance of a Concat model can be improved with attention weighted context, such as provided by the CAWC architecture to predict intent illustrated in the example embodiment of FIG. 4.

An attention vector comprised of one or more attention scores associated with the context vector and the one or more context features can be calculated based on at least one context vector and at least one query vector, such as using an attention module (AM). At least one attention weighted context vector can then be concatenated with at least one query embedding.

Example embodiments can include an attention-based feature weight generation mechanism in which attention weights are computed for one or more (e.g., each) of the one or more context features, based on both of the at least one query embedding and the at least one context embedding. This approach can enable the context-aware NLU to concentrate on relevant features, significantly mitigating potential issues associated with using only concatenation. For example, qᵢ and cᵢ can denote a query embedding vector and a context vector, respectively, for the i-th example. An attention module (AM) can receive qᵢ and cᵢ and generate an attention vector aᵢ, such as with a same length as cᵢ. A weighted context vector \tilde{c}ᵢ can be determined by performing element-wise multiplication (MUL) of aᵢ and cᵢ:

$${a}_{i} = AttentionModule ( {q}_{i} , {c}_{i} ) \qquad ( 4 )$$

$${\hat{c}}_{i} = {a}_{i} ⊙ {c}_{i} \qquad ( 5 )$$

where ⊙ represents element-wise multiplication

The weighted context vector \tilde{c}ᵢ comprised of one or more weighted context features can be concatenated with the at least one query embedding qᵢ, and a combined embedding fᵢ comprised of one or more combined embedding units can be input into an MLP.

As previously mentioned, the AM can receive the at least one context vector and the at least one query embedding vector as inputs and generate the attention vector that comprises the attention scores, such as for each of the one or more context features. Within the AM, both the query and context vectors can be passed through one or more linear layers represented by W_{q} and W_{c}, respectively, and subsequently concatenated to form a combined vector denoted as eᵢ. The vector eᵢ can be input through the two linear layers, represented by Wₗ₁ and Wₗ₂, with an amount (i.e., number) of neurons reduced (e.g., roughly halved) in each layer (e.g., each hidden layer). A tanh activation function can be applied after one or more (e.g., each) of the linear layers. The resultant vector can be passed through another linear layer, denoted by Wₗ₃, which can have an output vector length equal (e.g., a same length) to that of the context vector. A sigmoid activation function, σ, can then be applied to restrict each value to between 0 and 1. The resultant attention vector can be represented by ai.

$${e}_{i} = concat ( {W}_{q} {q}_{i} , {W}_{c} {c}_{i} ) \qquad ( 6 )$$

$${a}_{i} = σ ( {W}_{l 3} tanh ( {W}_{l 2} tanh ( {W}_{l 1} {e}_{i} ) ) ) \qquad ( 7 )$$

σ can represent the sigmoid function.

As aforementioned, using labels that account for context information can improve the context-aware NLU model performance.

### Labelling Strategy

As discussed, incorporating context information associated with context features to predict intent can assist the context-aware NLU model to more accurately predict an intent of a user, especially when a user utterance (e.g., a query) is imperfect (e.g., ambiguous, vague, includes typos, includes irrelevant information, and/or confounding information, etc.). Similarly, having context data/features aids in the proper annotation of data, which can subsequently enhance a performance of the context-aware NLU model. To reiterate, labeling examples solely based on user utterances can result in incorrect labels and corresponding incorrect extracted features in use, such as when a query of a user is vague. Example embodiments can involve examining a query of a user along with related context features from available context data for labeling examples in training, dynamic updating, and/or when predicting intent of a new user using the context-aware NLU model. While transaction history data can be used for the context data, the labelling process therefor can be extremely time-consuming and might not be scalable for large datasets, such as in the context of a customer care domain. Furthermore, transaction history data might not be readily available for a particular user, such as when a user into able to be identified (e.g., is not logged in, made a purchase as a guest, and/or does not identify themselves in an utterance, etc.). To overcome this dilemma, many example embodiments can use at least a portion (e.g., an entire) user-agent (human) conversation (e.g., conversation data) as the context data of the user (e.g., a proxy for the transaction history data), since conversation data is relatively easier to label. This conversation data of the user(s) can be an appropriate proxy for transaction history data of the user because most of the context information that can be derived from a transaction history of the user(s) is often mentioned during a user-agent conversation. Therefore, in example embodiments, we can have two types of labels, for each example:
1) Utterance Label: tagged based on one or more utterances of a user and intended to capture an explicit intent of the user.
2) Conversation Label: tagged based on a user-agent/chat model conversation and can capture a latent intent of a user.

Example embodiments can thus efficiently utilize the two types of labels for training the context-aware NLU model, dynamically updating the context-aware NLU model, and/or using the context-aware NLU model as deployed to extract features accordingly and predict intent of a new user.

As previously mentioned, training a chat model with only utterance labels from a user can be sub-optimal, since these labels are tagged solely based on a user utterance (e.g., the initial query of the user). Likewise, training chat models with only conversation labels can also be sub-optimal, as doing so can deviate from what a user has explicitly stated. For instance, when a user inputs “contact customer care” to a chat model, an utterance label could be “agent contact.” However, a conversation label (which generally indicates a latent intent of a user) could be about a “refund” and is only discerned by a human agent after further interactions with the user post-escalation. To address this, many example embodiments can employ the Multi-Task Learning (MTL) approach to train/dynamically update/use the context-aware NLU model.

### Multi-Task Learning (MTL) Paradigm for Contextual NLU (MTL-CNLU)

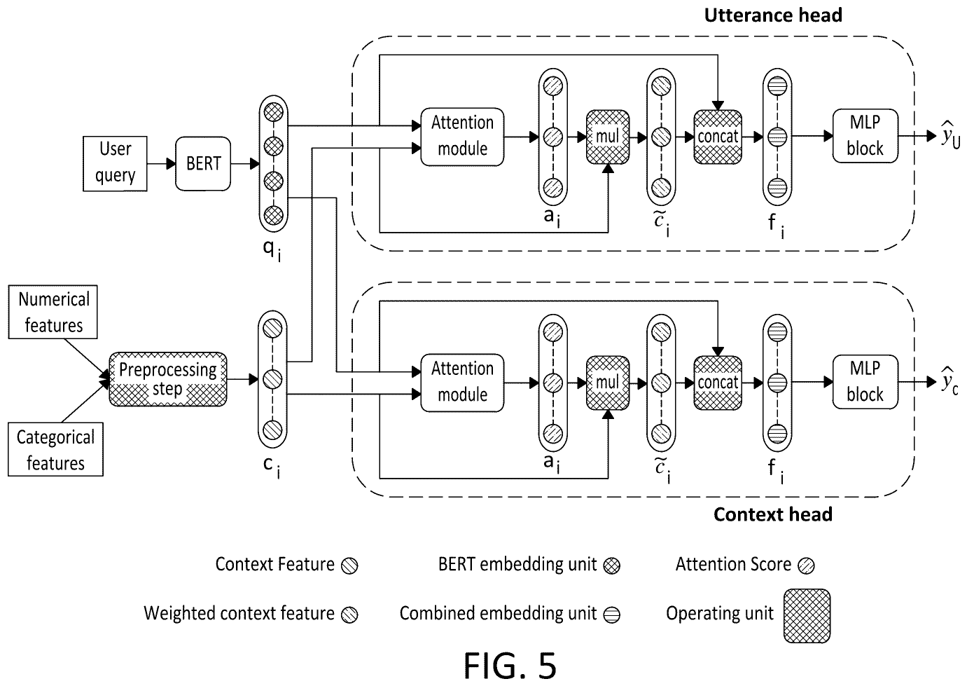

FIG. 5 illustrates a block diagram of a context-aware NLU model that includes a Multi-Task Learning (MTL) paradigm for Contextual NLU model (MTL-CNLU) for predicting user intent, according to an example embodiment. MTL is a training framework that can exploit valuable information within multiple related tasks, thereby enhancing generalization performance across the multiple related tasks. In many example embodiments, one task can be provided as a classification of an utterance intent of a user and another task can be provided as a classification of a conversation intent of the user. An utterance label and a conversation label can serve as ground truths for a first task and a second task, respectively. In most MTL models, initial layers are shared among the related tasks. In many example embodiments, the BERT model (e.g., the pre-trained backbone BERT model) can be shared between an utterance head (for predicting the utterance intent of the user) and a context head (for predicting the context intent of the user, which can also be referred to as a conversation intent of the user when conversation data is used as a proxy for transaction history data in use and/or for training, however, the disclosure is not limited thereto). One or more parameters of one or more of the BERT model, the utterance head, and the context head can be denoted by φ1, φ2 U, and φ2 C, respectively. A combined loss from the two heads, for example, can be utilized to jointly update the three parameters sets and is represented by:

$$£ combined = £ ( D ; ϕ 1 , ϕ2 U , ϕ 2 C ) \qquad ( 8 )$$

The combined loss can be a weighted sum of the cross-entropy losses from the two heads.

$$£ combined = £ ce ( Yu , {}^{\hat{}} Yu ) + λ£ ce ( Yc , {}^{\hat{}} Yu ) \qquad ( 9 )$$

where λ can be a hyperparameter employed to balance the two losses. Yᵤ, Y_{c}, \hat{ }Yᵤ, and \hat{ }Y_{c} represent the utterance labels, the context labels (e.g., conversation labels), the predicted utterance intents, and the predicted context intent (e.g., the conversation intent), respectively.

### Top Intent Selection

As discussed, the correct intent for the user in response to a query such as “contact customer care” is “agent contact,” as it captures an explicit intent of the user. However, example embodiments can also determine an implicit intent of a user, which in this instance was about a “refund,” as evidenced by the context information of the user. Determining the implicit intent of a user as well as the explicit intent of the query of the user can help to direct the user to an appropriate automated workflow of a chat model (e.g., a chat model included in the context-aware NLU model and/or an architecture thereof), accordingly. Many architectures of chat models predating MTL-CNLU had only one head (e.g., associated with a user query), so to obtain the top intents (e.g., most probable), such as the top 2 intents, the top intents would be determined based on confidence scores directly from the one head. In MTL-CNLU, the top intents (e.g., the top 2 intents) can include a top intent from the utterance head and a top intent from the context head (e.g., the conversation head). Additionally, a metric can be used to assess the context-aware NLU model and/or the architecture thereof performance(s) based on both predictions. For this purpose, models can be evaluated on the top 2 scores, as illustrated in Table 3.

TABLE 3

| | Utterance Intent | | Conversation Intent | | |
|---|---|---|---|---|---|
| Architecture | Micro F1(%) | Macro F1(%) | Micro F1(%) | Macro F1(%) | Top 2 Score(%) |
| Text only (baseline) | 78.65 | 75.80 | — | — | 86.12 |
| Concat | 80.14 | 77.28 | — | — | 87.34 |
| MLP + Concat | 80.28 | 77.66 | — | — | 87.23 |
| Unimodal | 79.66 | 76.01 | — | — | 86.14 |
| Gating | 80.45 | 77.42 | — | — | 87.41 |
| Weighted Sum | 80.12 | 77.37 | — | — | 86.98 |
| CAWC | 81.5 | 78.71 | — | — | 88.38 |
| MTL-CNLU | 81.65 | 78.80 | 38.65 | 37.80 | 89.90 |
| MTL-CNLU-AWC | 81.54 | 78.81 | 41.78 | 38.95 | 90.44 |
| MTL-CNLU-SAWC | 81.96 | 79.05 | 42.03 | 39.56 | 90.92 |

Table 3 shows results comparing performances of different models for predicting intent. The first (top) half of the table contains results from the baseline model (text only) as well as different models. The second (bottom) half of the table includes the example embodiments of the context aware NLU models and architectures thereof illustrated and described with respect to FIGS. 4-8. The first 7 models have single-headed architectures; therefore, no comparison can be made with respect to conversation labels. Top 2 score can be calculated based on the following algorithm:

Top 2 Score Calculation algorithm

```
if yᵤ = y_{c} then
  if y\hat{ }₁ = yᵤ or y\hat{ }₂ = yᵤ then
    score - 1
  else
    score - 0
  end if
else
  if y\hat{ }₁ E {yᵤ, y_{c}} and y\hat{ }₂ E {yᵤ, y_{c}} then
    score - 1
  else if y\hat{ }₁ E {yᵤ, y_{c}} or y\hat{ }₂ E {yᵤ, y_{c}} then
    score - 0.5
  else
    score - 0
  end if
end if
```

yᵤ, y_{c}, y\hat{ }1 and y\hat{ }2 can denote the utterance label, conversation label, 1st predicted intent and 2nd predicted intent respectively. For models with the single head the 1st and 2nd predicted intents are the top 2 intent classes with maximum confidence. For models with two heads, the intent from the utterance head is considered as the 1st predicted intent and intent from the context head (e.g., the conversation head) is the 2nd predicted intent.

### Architectures for MTL-CNLU

### MTL-CNLU

In an example embodiment, the pretrained BERT model can be the only component shared by both the utterance head and the context head (e.g., the conversation head). Each head can possess its own query-context combining mechanism, which can otherwise maintain a same architecture as the context aware NLU model that includes the CAWC shown and described with respect to FIG. 4. The comprehensive MTL-CNLU architecture can be seen in FIG. 5. The predicted intents from the utterance head and the context head (e.g., the conversation head) can be represented by y\hat{ }ᵤ and y\hat{ }_{c}, respectively. Other notations can remain unchanged from previous descriptions.

MTL-CNLU with Attention Weighted Context (MTL-CNLU-AWC)

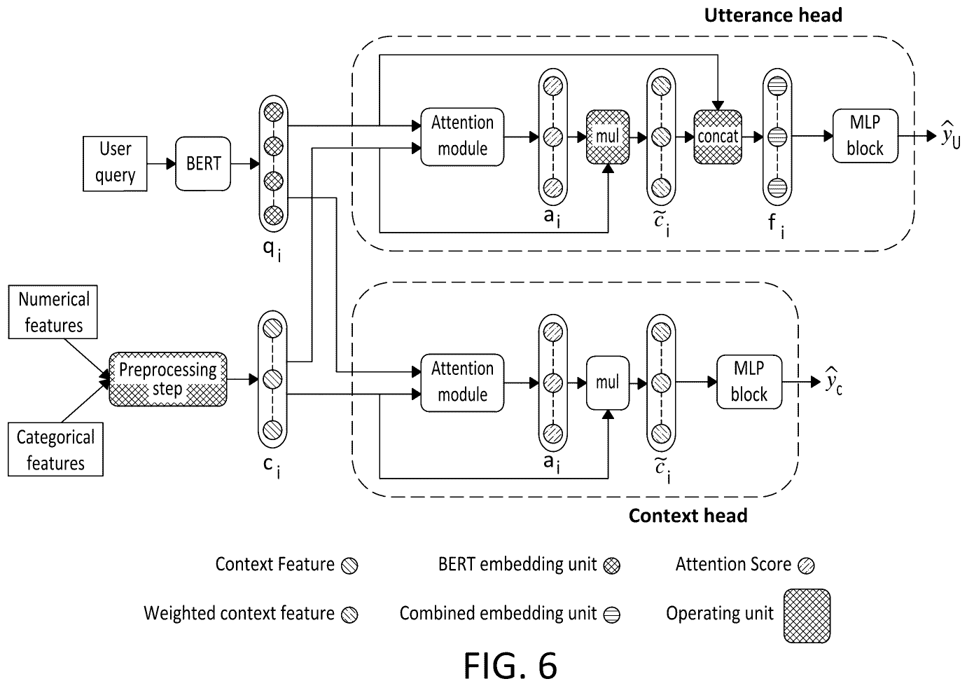

FIG. 6 illustrates a block diagram of a context-aware NLU model that includes an MTL-CNLU with Attention Weighted Context (MTL-CNLU-AWC) model for predicting user intent, according to an example embodiment. The concatenation of the query and weighted context vector for predicting intents works effectively for the utterance head. However, due to the context vector's sparse nature (attributed to the presence of categorical features) and its comparatively shorter length (the context vector has a length of 50, while the query vector has a length of 768), concatenating the query embedding (also referred to herein as a query vector or a query embedding vector) and a context vector can cause a chat model to focus more on the query of the user than the context (e.g., conversation) of the user. For instance, training data in many example embodiments include an utterance “hello there” labeled with “greet” for utterance and “why order was cancelled” for the conversation. Based on the context data, “why order was cancelled” was deemed the appropriate intent since the order had been cancelled by the store due to items being out of stock. However, when trained on this data, the context-aware NLU model formed a strong association between the utterance labels and the context conversation labels. Consequently, during inference, when a user with a latent intent of tracking their order status entered the query “hello there,” the model predicted “greet” and “why order was cancelled” as the intents from the utterance and conversation heads, respectively, instead of “greet” and “where is my order.”

Since the conversation head's primary objective is to predict the user's latent intent, the query-context combining module was removed from the conversation head to offer a further improvement in intent prediction. Only the weighted context vector can be fed into the MLP block to predict latent intents.

In an example embodiment, a user intent predicted by the context-aware NLU model can be classified into one of two categories:

Flow intent: Intents associated with a defined flow. When a user selects a flow intent, they can follow a series of predefined steps to resolve their query. Examples of flow intents can include “where is my order,” “why order was cancelled,” and “where is my refund”, etc.

Non-flow intent: Intents that do not have an associated flow. This can include intents like “agent contact,” “greet,” “affirmative,” etc.

Utterance labels can be either flow or non-flow intents, while conversation labels can be flow intents.

MTL-CNLU with Selective Attention Weighted Context (MTL-CNLU-SAWC)

FIG. 7 illustrates a block diagram of a context-aware NLU model that includes an MTL-CNLU with Selective Attention Weighted Context (MTL-CNLU-SAWC) model for predicting user intent, according to an example embodiment. The attention weights, which are derived using both context and query embeddings as previously described, can assist example embodiments of the context-aware NLU model in focusing on relevant context features for training, dynamic updating, and/or predicting intent of a new user post-deployment. For instance, consider a user inputting the query “late.” The context vector includes information that the user ordered two items: one was canceled by the store, and the other was delayed. The model can determine which of these two context features to use: “are any items delayed” or “are any items canceled.” This cannot be determined by a chat model based solely on the context features. The query vector aids the context-aware NLU model in focusing on the most relevant context features. However, for utterances such as “contact customer care” and “talk to representative,” the query embedding may, in some embodiments, not influence the latent intent prediction, as there is no relevant information in the query regarding the user's latent intent. In fact, for utterances where the explicit intent corresponds to a non-flow intent, the latent intent prediction can depend on the context vector. To accomplish this, we can modify the architecture of the context-aware NLU model illustrated in FIG. 6 such that the context vector c is element-wise multiplied with the attention vector when the utterance head predicts a flow intent. In other cases, only c can be input to the context head (e.g., the conversation head). The example embodiment of the context-aware NLU model that includes the MTL-CNLU-SAWC can thus further improve prediction of intent.

FIG. 8 illustrates a block diagram of a system that can include a context-aware NLU model that can include one of the architectures used to predict intent illustrated in the example embodiments of FIG. 5, 6, or 7, according to an example embodiment.

System 800 is an example, and embodiments of the system 800 are not limited to the example embodiments presented herein. In many example embodiments, the system 800 can include a website 818 (e.g., an ecommerce marketplace website, a vendor website, a dedicated website for hosting a context-aware NLU model 810, and/or a customer care agent website, etc.), the context-aware NLU model 810, a database system 817, and/or a web server 820. The context-aware NLU model can include an architecture comprised of subcomponents, such as an utterance head 811, a context head (e.g., a conversation head) 812, a Bidirectional Encoder Representations from Transformers (BERT) model 815, and/or a preprocessing step model (also referred to herein as a preprocessor) 816. The utterance head 811 can include an attention module (AM) 813a and a multilayer perceptron (MLP) (also referred to herein as an MLP model) 814a. The context head (e.g., the conversation head) can include an AM 813b and an MLP 814b. In some example embodiments, the BERT model 815 can be pre-trained and mutually utilized by both the utterance head 811 and the context head (e.g., the conversation head) 812. Generally, the system 800 can be implemented with hardware and/or software, as described herein.

One or more of the system 800, the subcomponents thereof, and/or the web server 820 can include a computer system, such as the computer system 100 (illustrated and described with respect to FIG. 1), and one or more can be a single computer; a single server; a cluster or collection of computers or servers; a cloud of computers or servers; and/or a combination thereof. In some example embodiments, a single computer system can host the system 800, the subcomponents thereof, and/or the web server 820.

In some example embodiments, the web server 820 can be in data communication with at least one user device 840 of at least one user 850 via a network 830. Types of the user 850 can include a customer service representative (e.g., a customer care agent), a user (e.g., a customer), an expert (e.g., individual that manages, trains, tunes/updates, maintains, monitors and/or audits performance metrics of the context-aware NLU model 810), etc. Associated interfaces and permissions related to the system 800 can differ as appropriate for the type of the user device 840, the user 850, predetermined authorizations, and/or predetermined purposes of the user 850. The user device 840 can be included in the system 800 or external to system 800 and communicatively coupled thereto via the network 830. The network 830 can be the Internet or another suitable network for inter-device connectivity. In some example embodiments, the web server 820 can host the website 818, other websites, and/or mobile application servers, etc. For example, the web server 820 can host the website 818, or provide a server that interfaces with an application (e.g., a mobile application), on the user device 840, which can allow the user 850 to interact with the context-aware NLU model 810, such as for predicting intent using a context-aware NLU model to assist a user and/or enabling performance of activities associated with an expert.

In some example embodiments, an internal network that is not open to the public can be used for communications between the context-aware NLU model 810, the subcomponents in an architecture thereof, the database system 817, the website 818, and/or the web server 820 within the system 800. Accordingly, in some example embodiments, the context-aware NLU model 810, the subcomponents of an architecture thereof, and/or software used thereby can refer to a back end of the system 800 operated by a specialist/expert, a customer service representative, and/or a network administrator of the system 800. The web server 820 (and/or software used by such systems) can refer to a front end of system 800, which can be accessed and/or otherwise used by the user 850 via the user device 840. In these or other example embodiments, the expert, the customer service representative, and/or the network administrator of the system 800 can manage the system 800, the subcomponents of the architecture thereof, the processor(s) of the system 800, and/or the memory storage unit(s) of the system 800 using the input device(s) and/or display device(s) of the system 800.

In some example embodiments, the user device 840 can include a desktop computer, a laptop computer, a mobile device, and/or another endpoint device used by the user 850. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.).

In some example embodiments, the context-aware NLU model 810, the subcomponents of the architecture thereof, and/or the web server 820 can each include at least one input device (e.g., at least one keyboards, at least one keypads, at least one pointing devices such as a computer mouse or computer mice, at least one touchscreen displays, a microphone, etc.), and/or can include at least one display device (e.g., at least one monitor, at least one touch screen display, projector, etc.). In these example embodiments or other example embodiments, at least one of the input device(s) can be similar or identical to the keyboard 104 (FIG. 1) and/or the mouse 110 (FIG. 1). Further, at least one of the display device(s) can be similar or identical to the monitor 106 (FIG. 1) and/or the screen 108 (FIG. 1). The input device(s) and the display device(s) can be coupled to the context-aware NLU model 810, the subcomponents of the architecture thereof, and/or the web server 820 in a wired manner and/or a wireless manner, and the coupling can be direct and/or indirect, as well as local and/or remote. As an example of an indirect manner (which may or may not also be a remote manner), a keyboard-video-mouse (KVM) switch can be used to couple the input device(s) and the display device(s) to the processor(s) and/or the memory storage unit(s). In some example embodiments, the KVM switch also can be part of the context-aware NLU model 810 and/or the web server 820. In a similar manner, the processors and/or the non-transitory computer-readable media can be local and/or remote to each other.

In some example embodiments, the context-aware NLU model 810, the subcomponents of the architecture thereof, and/or the web server 820 can be further connected to communicate with at least one database system 817. The database system 817 can include and/or be connected to one or more repositories that can include, for example: training data; context-aware NLU model performance metrics data; product/item catalog data; identifying data for the user 850 and/or the user device 840; utterance data of the user 850; and/or context data (e.g., transaction history data and/or conversation data) of the user 850, etc. For example, the training data can include one or more of product/item catalog features (e.g., name, brand, description, dimensions, price, inventory, etc.), context (e.g., transaction history and/or conversation) features, utterance features, utterance labels, context (e.g., transaction history and/or conversation) labels, context (e.g., transaction history and/or conversation) predicted/labelled intents, flow/non-flow intents, automated workflows and/or steps/prompts thereof, utterance predicted/labelled intents, weights and/or biases of the context-aware NLU model 810, versions of the context-aware NLU model 810, weights and/or biases of the subcomponents of the architectures of the context-aware NLU model 810, versions of one or more subcomponents and/or architectures of the context-aware NLU model 810, training datasets, update schedule/log, etc. The performance data associated with the context-aware NLU model 810 can include metrics/analytics/monitored data associated with the context-aware NLU model 810 use, such as user feedback, user surveys, an amount of escalations per user and/or overall, an amount of escalations relative to a predetermined baseline per user and/or overall, an amount of resolutions relative to a predetermined baseline per user and/or overall, patterns associated with at least one step/position in an automated workflow, such as that precede an escalation/resolution, time to escalation/resolution per user and/or overall, and/or scores/percentages/relevance of predicted user intent partial/total accuracy per user and/or overall, etc. The utterance data of the user(s) 850 can include utterances (e.g., queries), query embeddings/vector/features, responses of the user to steps in an automated workflow, backgrounds, explanations, descriptions, common typos, clarifications, narratives, etc. The identifying data related to the user 850 can include login credentials, legal names, user memberships/classes, recognized devices, names/addresses input by the user(s), names/addresses associated with order numbers of the user, purchased items of the user(s), and/or IP addresses of the user(s), etc. The context (e.g., the conversation) data related to the user 850 can include order histories, transaction histories, partial/total delivery/performance of items/products/services, delivery/performance tracking, steps/positions of steps in an automated workflow, escalations, resolutions, time from query to prior and/or sub-query escalations/resolutions, and/or an amount and/or duration of contacts before escalations/resolutions, etc.

The database system 817 and/or repositories/databases thereof can be stored in at least one memory storage units (e.g., non-transitory computer readable media), which can be similar or identical to the at least one memory storage units (e.g., non-transitory computer readable media) described above with respect to computer system 100 (FIG. 1). Also, in some embodiments, one or more databases/repositories included in the database system 817 can be stored on a single memory storage unit, or the contents of that particular database can be spread across multiple ones of the memory storage units storing the at least one databases, depending on the size of the particular database and/or the storage capacity of the memory storage units.

The at least one databases can each include a structured (e.g., indexed) collection of data and can be managed by a suitable database management systems configured to define, create, query, organize, update, and manage database(s). Example database management systems can include MySQL (Structured Query Language) Database, PostgreSQL Database, Microsoft SQL Server Database, Oracle Database, SAP (Systems, Applications, & Products) Database, and IBM DB2 Database.

The context-aware NLU model 810, subcomponents and/or architectures thereof, the web server 820, the database system 817 and/or the at least one databases can be implemented using a suitable manner of wired and/or wireless communication.

Accordingly, the system 800 can include software and/or hardware components configured to implement the wired and/or wireless communication. Further, the wired and/or wireless communication can be implemented using a singular or plural combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Example PAN protocol(s) can include Bluetooth, Zigbee, Wireless Universal Serial Bus (USB), Z-Wave, etc.; example LAN and/or WAN protocol(s) can include Institute of Electrical and Electronic Engineers (IEEE) 802.3 (also known as Ethernet), IEEE 802.11 (also known as WiFi), etc.; and example wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, example communication hardware can include wired communication hardware including, for example, at least one data buses, such as, for example, universal serial bus(es), at least one networking cables, such as, for example, coaxial cable(s), optical fiber cable(s), and/or twisted pair cable(s), any other suitable data cable, etc. Further example communication hardware can include wireless communication hardware including, for example, at least one radio transceivers, at least one infrared transceivers, etc. Additional example communication hardware can include at least one networking components (e.g., modulator-demodulator components, gateway components, etc.).

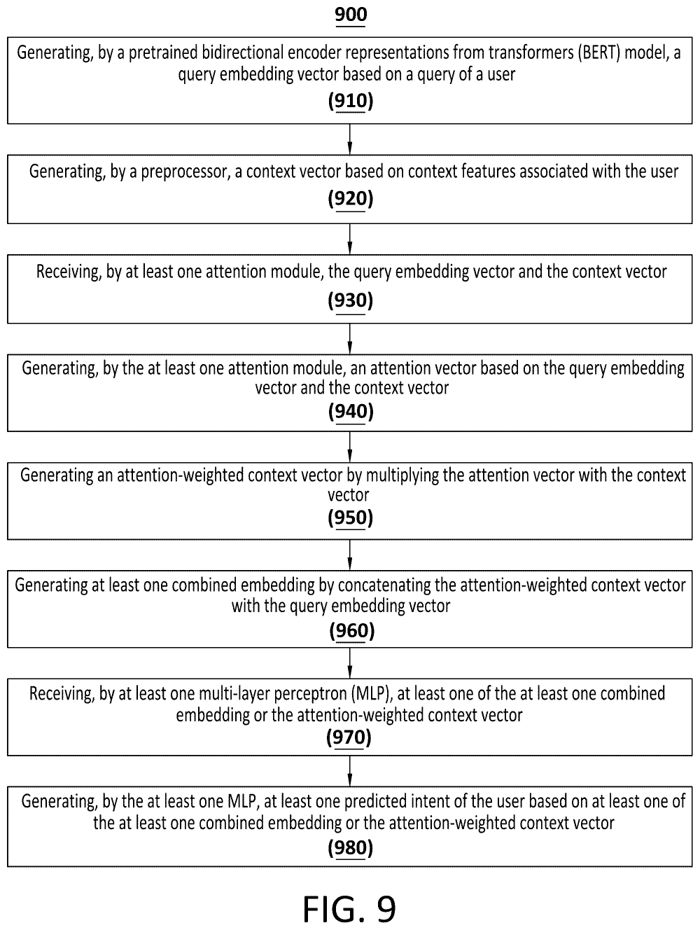

FIG. 9 illustrates a flowchart for a method 900 of predicting user intent using a context aware NLU model, according to an example embodiment. The method 900 is merely an example, and the method is not limited to the embodiments presented herein. The method 900 can be employed in many different embodiments or examples not specifically depicted or described herein. In some example embodiments, the procedures, the processes, and/or the activities of the method 900 can be performed in the order presented. In other example embodiments, the procedures, the processes, and/or the activities of the method 900 can be performed in any suitable order. In still other example embodiments, one or more of the procedures, the processes, and/or the activities of the method 900 can be combined or skipped.

In many embodiments, the system 800 (FIG. 8) can be suitable to perform method 900 and/or one or more of the activities of the method 900. In these or other example embodiments, one or more of the activities/steps of the method 900 can be implemented as one or more computing instructions configured to run at one or more processors and configured to be stored at one or more non-transitory computer readable media. Such non-transitory computer readable media can be part of system 800 (FIG. 8). The processor(s) can be similar or identical to the processor(s) described above with respect to the computer system 100 (FIG. 1). In some embodiments, the method 900 and other activities in the method 900 can include using a distributed network including distributed memory architecture to perform the associated activity. This distributed architecture can reduce the impact on the network and system resources to reduce congestion in bottlenecks while still allowing data to be accessible from a central location.

In many example embodiments, the method 900 can include an activity 910 of generating, by a pretrained bidirectional encoder representations from transformers (BERT) model, a query embedding vector based on a query of a user.

In many example embodiments, the method 900 can include an activity 920 of generating, by a preprocessor, a context vector based on context features associated with the user.

In many example embodiments, the method 900 can include an activity 930 of receiving, by at least one attention module, the query embedding vector and the context vector.

In many example embodiments, the method 900 can include an activity 940 of generating, by the at least one attention module, an attention vector based on the query embedding vector and the context vector. In many embodiments, the attention vector has a same vector length as a vector length of the context vector.

In many example embodiments, the method 900 can include an activity 950 of generating an attention-weighted context vector by multiplying the attention vector with the context vector.

In many example embodiments, the method 900 can include an activity 960 of generating at least one combined embedding by concatenating the attention-weighted context vector with the query embedding vector.

In many example embodiments, the method 900 can include an activity 970 of receiving, by at least one multi-layer perceptron (MLP), at least one of the at least one combined embedding or the attention-weighted context vector.

In many example embodiments, the method 900 can include an activity 980 of generating, by the at least one MLP, at least one predicted intent of the user based on at least one of the at least one combined embedding or the attention-weighted context vector.

The methods and systems described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these example embodiments will be apparent to those skilled in the art and may be made without departing from the scope or spirit of these disclosures.

Although predicting intent using a context-aware NLU model that can include architectures of example embodiments have been illustrated and described herein, it shall be understood by those skilled in the art that various changes may be made without departing from the spirit or scope of the disclosure. Accordingly, the disclosure of the example embodiments is intended to be illustrative of the scope of the disclosure and is not intended to be limiting. It is intended that the scope of the disclosure shall be limited only to the extent required by the appended claims.

Replacement of at least one claimed elements constitutes reconstruction and not repair. Additionally, benefits, other advantages, and solutions to problems have been described regarding example embodiments. The benefits, advantages, solutions to problems, and any element or elements that may cause any benefit, advantage, or solution to occur or become more pronounced, however, are not to be construed as critical, required, or essential features or elements of any or all the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
a processor; and
a non-transitory computer-readable medium storing computing instructions that, when executed on the processor, cause the processor to perform operations comprising:
generating, by a pretrained bidirectional encoder representations from transformers (BERT) model, a query embedding vector based on a query of a user;
generating, by a preprocessor, a context vector based on context features associated with the user;
receiving, by at least one attention component, the query embedding vector and the context vector;
generating, by the at least one attention component, an attention vector based on the query embedding vector and the context vector;
generating an attention-weighted context vector by multiplying the attention vector with the context vector;
generating at least one combined embedding by concatenating the attention-weighted context vector with the query embedding vector;
receiving, by at least one multi-layer perceptron (MLP) of a context-aware natural language understanding (NLU) model, at least one of the at least one combined embedding or the attention-weighted context vector; and
generating, by the at least one MLP, at least one predicted intent of the user based on at least one of the at least one combined embedding or the attention-weighted context vector.

2. The system of claim 1, wherein generating the attention vector further comprises:
passing the query embedding vector and the context vector through a first linear layer and a second linear layer;
concatenating the query embedding vector and the context vector to form a combined vector;
passing the combined vector through a third linear layer and a fourth linear layer, wherein a quantity of neurons is roughly halved in each of the third linear layer and the fourth linear layer;
applying a tanh activation function after each of the third linear layer and the fourth linear layer to generate a first resulting vector;
passing the first resulting vector through a fifth linear layer to generate a second resulting vector, wherein the second resulting vector has a vector length equal to a vector length of the context vector; and
applying a sigmoid activation function to generate a resulting attention vector.

3. The system of claim 1, wherein:
the context-aware NLU model includes an utterance head and a context head; and
the at least one predicted intent of the user comprises a predicted intent of the utterance head and a predicted intent of the context head.

4. The system of claim 3, wherein:
the at least one attention component comprises a first attention component included in the utterance head and a second attention component included in the context head; and
receiving the query embedding vector and the context vector, and generating the attention vector are performed by both the first attention component included in the utterance head and the second attention component included in the context head.

5. The system of claim 3, wherein the pretrained BERT model is shared by both the utterance head and the context head.

6. The system of claim 3, wherein the at least one MLP comprises a first MLP that is included in the utterance head and a second MLP that is included in the context head.

7. The system of claim 6, wherein generating the at least one predicted intent of the user further comprises:
generating, by the first MLP included in the utterance head, the predicted intent of the utterance head based on the at least one combined embedding.

8. The system of claim 6, wherein generating the at least one predicted intent of the user further comprises:
generating, by the second MLP included in the context head, the predicted intent of the context head based on the attention-weighted context vector when the predicted intent of the utterance head corresponds to a flow intent of a chat model engaged by the user, wherein the chat model is included in the context-aware NLU model; and
generating, by the second MLP included in the context head, the predicted intent of the context head based on the context features associated with the user directly when the predicted intent of the utterance head does not correspond to the flow intent of the chat model engaged by the user.

9. The system of claim 3, further comprising:
training the utterance head and the context head together in a multi-task learning (MTL) paradigm;
determining a combined loss from the utterance head and the context head; and
updating, based on the combined loss, at least one of one or more parameters of the pretrained BERT model that is shared by both the utterance head and the context head, one or more parameters of the utterance head, or one or more parameters of the context head.

10. The system of claim 9, wherein:
training the context head is at least partially based on conversation labels of conversation data for at least one conversation of at least one prior user;
the conversation labels correspond to context features associated with the at least one prior user;
the conversation labels are related to a latent intent of the at least one prior user; and
the conversation data is used as a proxy for context data of the at least one prior user.

11. A computer-implemented method of predicting intent with a context-aware natural language understanding (NLU) model, the computer-implemented method comprising:
generating a query embedding vector based on a query of a user;
generating a context vector based on context features associated with the user;
generating an attention vector based on the query embedding vector and the context vector;
generating an attention-weighted context vector by multiplying the attention vector with the context vector;
generating at least one combined embedding by concatenating the attention-weighted context vector with the query embedding vector;
receiving, by at least one multi-layer perceptron (MLP), at least one of the at least one combined embedding or the attention-weighted context vector; and
generating, by the at least one MLP, at least one predicted intent of the user based on at least one of the at least one combined embedding or the attention-weighted context vector.

12. The computer-implemented method of claim 11, further comprising:
receiving the query of the user via an input of the user to a chat model, wherein the chat model is included in the context-aware NLU model; and
receiving the context features associated with the user via at least one of a transaction history of the user or a conversation history of the user.

13. The computer-implemented method of claim 12, wherein the conversation history of the user includes utterances of the user during at least one conversation between the user and at least one of a customer care agent or the chat model.

14. The computer-implemented method of claim 11, wherein:
the context-aware NLU model includes an utterance head and a context head; and
the at least one predicted intent of the user comprises a predicted intent of the utterance head and a predicted intent of the context head.

15. A non-transitory computer-readable medium storing instructions, the instructions, upon execution by a processor, cause the processor to perform operations comprising:
receiving, by a pretrained bidirectional encoder representations from transformers (BERT) model, a query of a user;
receiving, by a preprocessor, context features associated with context data of the user;
generating, by the pretrained BERT model, a query embedding vector based on the query of the user;
generating, by the preprocessor, a context vector based on the context features associated with context data of the user;
receiving, by at least one attention component, the query embedding vector and the context vector;
generating, by the at least one attention component, an attention vector based on the query embedding vector and the context vector;
generating an attention-weighted context vector by multiplying the attention vector with the context vector;
generating at least one combined embedding by concatenating the attention-weighted context vector with the query embedding vector;
receiving, by at least one multi-layer perceptron (MLP) of a context-aware natural language understanding (NLU) model, at least one of the at least one combined embedding or the attention-weighted context vector; and
generating, by the at least one MLP, at least one predicted intent of the user based on at least one of the at least one combined embedding or the attention-weighted context vector.

16. The non-transitory computer-readable medium of claim 15, wherein generating the attention vector further comprises:
passing the query embedding vector and the context vector through a first linear layer and a second linear layer;
concatenating the query embedding vector and the context vector to form a combined vector;
passing the combined vector through a third linear layer and a fourth linear layer, wherein a quantity of neurons is roughly halved in each of the third linear layer and the fourth linear layer;
applying a tanh activation function after each of the third linear layer and the fourth linear layer to generate a first resulting vector;
passing the first resulting vector through a fifth linear layer to generate a second resulting vector, wherein the second resulting vector has a vector length equal to a vector length of the context vector; and
applying a sigmoid activation function to generate a resulting attention vector.

17. The non-transitory computer-readable medium of claim 15, wherein:
the context-aware NLU model includes an utterance head and a context head; and
the at least one predicted intent of the user comprises a predicted intent of the utterance head and a predicted intent of the context head.

18. The non-transitory computer-readable medium of claim 17, wherein:
the at least one attention component comprises a first attention component included in the utterance head and a second attention component included in the context head; and
receiving the query embedding vector and the context vector, and generating the attention vector are performed by both the first attention component included in the utterance head and the second attention component included in the context head.

19. The non-transitory computer-readable medium of claim 17, wherein the pretrained BERT model is shared by both the utterance head and the context head.

20. The non-transitory computer-readable medium of claim 17, wherein the at least one MLP comprises a first MLP that is included in the utterance head and a second MLP that is included in the context head.
